(19) United States
(12) Patent Application Publication
(10) Pub. No.: US 2024/0385886 A1
(43) Pub. Date: Nov. 21, 2024

(54) DYNAMIC TRANSLATION AND OPTIMIZATION FOR SPATIAL ACCELERATION ARCHITECTURES

(71) Applicant: The Board of Trustees of the University of Illinois, Urbana, IL (US)

(72) Inventors: Nam Sung Kim, Champaign, IL (US); Dong Kai Wang, Urbana, IL (US)

(21) Appl. No.: 18/663,713

(22) Filed: May 14, 2024

Related U.S. Application Data
(60) Provisional application No. 63/502,248, filed on May 15, 2023.

(51) Int. Cl. G06F 9/50

(52) U.S. Cl. CPC G06F 9/5027; G06F 2209/501

(57) ABSTRACT

A method for translation and optimization for acceleration and its circuit are disclosed. The method includes: detecting a code region executing on a central processing unit (CPU) core for acceleration, the code region comprising a plurality of instructions; mapping, in hardware, the plurality of instructions in linear order to a planar grid for a spatial accelerator; configuring the spatial accelerator based on the planar grid; and transferring control to the spatial accelerator to execute the code region. Other aspects, embodiments, and features are also claimed and described.

### CROSS-REFERENCE TO RELATED APPLICATION

This application claims priority to U.S. Provisional Application No. 63/502,248, filed on May 15, 2023, titled “DYNAMIC TRANSLATION AND OPTIMIZATION FOR SPATIAL ACCELERATION ARCHITECTURES,” the entirety of which is incorporated herein by reference.

### STATEMENT OF GOVERNMENT SUPPORT

N/A

### INTRODUCTION

Modern heterogeneous central processing units (CPUs) use hardware accelerators to enable domain-specialized execution and achieve improved efficiency. Among the accelerators, spatial accelerators can accelerate a wide range of compute-heavy and data-parallel applications. However, the spatial accelerators may require specialized compilers and software stacks, libraries, or domain-specific languages to operate and may not be utilized with ease by all applications. As a result, the accelerator's large pool of compute and memory resources can sit wastefully idle when it is not explicitly programmed. As the demand for efficient computer processing continues to increase, research and development continue to advance processor technologies to meet the growing demand for improved processing and energy efficiency using CPUs and accelerators.

### SUMMARY

The following presents a simplified summary of one or more aspects of the present disclosure, in order to provide a basic understanding of such aspects. This summary is not an extensive overview of all contemplated features of the disclosure, and is intended neither to identify key or critical elements of all aspects of the disclosure nor to delineate the scope of any or all aspects of the disclosure. Its sole purpose is to present some concepts of one or more aspects of the disclosure in a simplified form as a prelude to the more detailed description that is presented later.

In one example, a method for translation and optimization for acceleration is disclosed. The method includes detecting a code region queued for executing on a central processing unit (CPU) core for acceleration, the code region comprising a plurality of instructions; mapping, in hardware, the plurality of instructions in linear order to a planar grid for a spatial accelerator; configuring the spatial accelerator based on the planar grid; and transferring control to the spatial accelerator to execute the code region.

In another example, a circuit for translation and optimization for acceleration is disclosed. The circuit includes: a memory comprising: a spatial dataflow graph, and a control circuit coupled to the memory. The control circuit is configured to: detect a code region queued for executing on a central processing unit (CPU) core for acceleration, the code region comprising a plurality of instructions; map in hardware the plurality of instructions in linear order to a planar grid of the spatial dataflow graph for a spatial accelerator; configure the spatial accelerator based on the planar grid; and transfer control to the spatial accelerator to execute the code region.

These and other aspects of the invention will become more fully understood upon a review of the detailed description, which follows. Other aspects, features, and embodiments of the present invention will become apparent to those of ordinary skill in the art, upon reviewing the following description of specific, exemplary embodiments of the present invention in conjunction with the accompanying figures. While features of the present invention may be discussed relative to certain embodiments and figures below, all embodiments of the present invention can include one or more of the advantageous features discussed herein. In other words, while one or more embodiments may be discussed as having certain advantageous features, one or more of such features may also be used in accordance with the various embodiments of the invention discussed herein. In similar fashion, while exemplary embodiments may be discussed below as device, system, or method embodiments it should be understood that such exemplary embodiments can be implemented in various devices, systems, and methods.

### BRIEF DESCRIPTION OF THE DRAWINGS

FIG. 1 is an illustration of an example architecture including a hardware controller according to some embodiments.

FIG. 2 is a flow chart illustrating an exemplary process for translation and optimization for acceleration according to some aspects of the disclosure.

FIG. 3 is an illustration of an example dataflow graph with instructions according to some embodiments.

FIG. 4 shows how a hardware controller builds and refines a DFG-based architecture model to optimize and configure a spatial accelerator according to some embodiments.

FIG. 5 is an illustration of dependent instruction placement examples according to some embodiments.

FIG. 6 is an illustration of a subgraph duplication example when configuring a spatial accelerator according to some embodiments.

FIG. 7 is an illustration of example load/store entries, which are interconnected to processing elements but maintain original program orders according to some embodiments.

FIG. 8 is an illustration of an example hardware controller's architecture according to some embodiments.

FIG. 9 is an illustration of an example timing diagram of instruction mapping stages according to some embodiments.

FIG. 10 is an illustration of an example interconnect used for the test accelerator with direct connections to its neighboring units and a simple on-chip network for distant traversals according to some embodiments.

FIG. 11 is an illustration of example hardware synthesis of the hardware controller 106 and a custom spatial accelerator according to some embodiments.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, those skilled in the art will readily recognize that these concepts may be practiced without these specific details. In some instances, this description provides well known structures and components in block diagram form in order to avoid obscuring such concepts.

In some examples, a disclosed hardware controller (e.g., a circuit, a hardware on-chip controller, a hardware block on the CPU) and a method using the hardware controller address inefficiencies of the general-purpose processors and the accelerators, such as, for example, the above-noted inefficiencies. For example, the disclosed hardware controller and method can build and maintain a dataflow graph (DFG)-based architecture model based on real-time measured performance data. With this model, the disclosed hardware controller and method can locally minimize expected instruction latency by using a spatial mapping algorithm. In addition, the disclosed hardware controller and method can use runtime information continuously gathered from performance counters on the accelerator as inputs to iteratively optimize its spatial architecture and perform reconfiguration. For loops that are explicitly identified to be parallelizable (e.g., using OpenMP pragmas), the disclosed hardware controller and method can additionally apply iteration-level parallel optimizations such as, for example, pipelining and unrolling. In addition, the disclosed hardware controller and method can use a register transfer level (RTL)-level implementation, which can be interfaced with existing RISC-V cores. Further, the disclosed hardware controller and method can repurpose idle accelerator resources when the resources are not used conventionally. In addition, the disclosed hardware controller and method can partially eliminate von Neumann overhead present in CPU cores by executing a thread on the accelerator. Thus, the disclosed hardware controller and method can improve energy efficiency as well.

Backed by a synthesized RTL implementation, the feasibility of the microarchitectural solution was evaluated with different accelerator configurations. Across the Rodinia benchmarks, results demonstrate an average 1.3× speedup in performance and 1.8× gain in energy efficiency against a multicore CPU baseline.

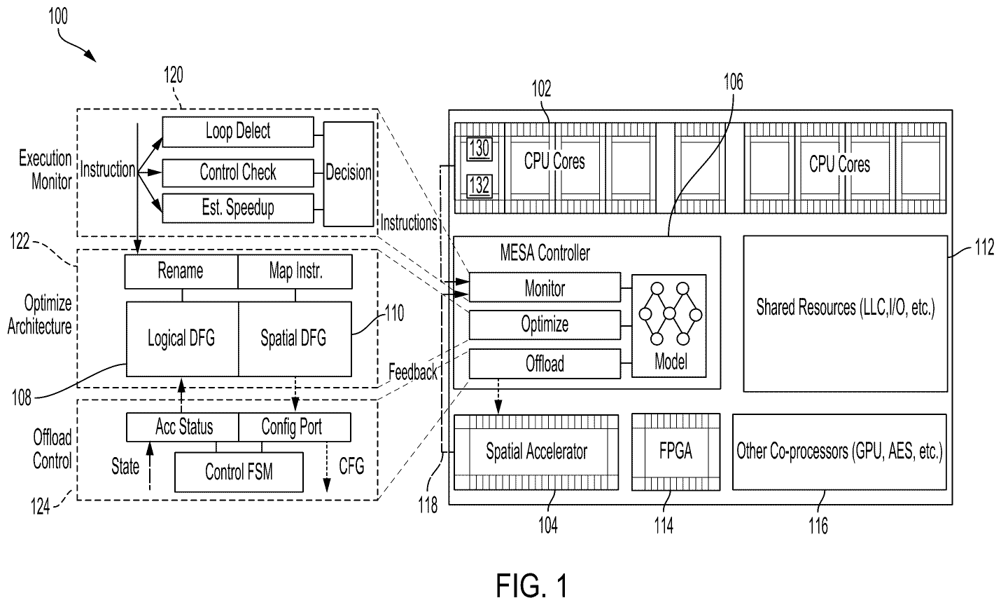

FIG. 1 is an illustration of an example architecture 100. The architecture 100 can include central processing unit (CPU) core(s) 102 (also referred to as CPU 102), an accelerator 104, and a hardware controller 106. In some examples, each of the CPU cores 102 can be a general-purpose processor to process instructions in program order. In further examples, the example architecture 100 can include a multi-core processor including multiple CPU cores 102. In some examples, the accelerator 104 can include a spatial accelerator including a spatial array of processing elements (PEs) to accelerate a wide range of compute-heavy and data-parallel applications. In some examples, the architecture 100 may further include shared resources 112, a field programmable gate array (FPGA) 114, and/or other co-processors 116, as illustrated in FIG. 1. However, in some examples, one or more of the shared resources 112, FPGA 114, and other co-processor 116 are not present in the architecture 100.

In some examples, the hardware controller 106 is an on-chip hardware controller, a hardware controller on the CPU, a circuit on the CPU, or any other suitable hardware circuit. The hardware controller 106 can map an instruction sequence (i.e., an ordered linear sequence of operations or operations in program order) from the CPU 102 to the spatial accelerator 104. The hardware controller 106 can be a middle-ground architecture abstraction layer in the form of a DFG equipped with some additional features to convert the machine code from the CPU core(s) 102 to the configuration bitstream for the spatial accelerator 104.

In some examples, the hardware controller 106 exploits a DFG model. FIG. 1 illustrates three functional blocks of the hardware controller 106 including a monitoring block 120, a translation block 122, and a mapping block 124. The functional blocks may be implemented via software and/or hardware of the hardware controller 106. In some examples, the hardware controller 106 can monitor program execution on the CPU 102 to assess viability for acceleration (via the monitoring block 120), dynamically translate the program binary to latency-weighted dataflow graphs (DFGs) (via the translation block 122), and map DFGs to a configurable spatial accelerator (e.g., the spatial accelerator 104) (via the mapping block 124). The hardware controller may further iteratively optimize and reconfigure the accelerator 104. In some examples, the dynamic translation can indicate converting, in hardware and in real time, the program to DFGs. In further examples, the DFG abstraction provides a data structure that can be easily manipulated such that the instruction mapping algorithm does not have to deal with underlying hardware directly. For example, the hardware controller 106 assures that changes to the DFG are reflected in hardware during the eventual configuration step. In further examples, the DFG allows performance modelling using estimated or measured delays through, for example, performance counters at functional units or processing elements and load-store units on the accelerator and/or the CPU core(s) 102.

In further examples, the hardware controller 106 includes two hardware data structures: the Logical DFG (LDFG) 108 and the Spatial DFG (SDFG) 110. In some examples, the hardware controller 106 can include a memory to store the two hardware data structures. In further examples, the CPU or the accelerator does not need to access the LDFG 108 or the SDFG 110. In some examples, the LDFG stores a linear view of the graph (indexed in program order, which is analogous to the CPU's reorder buffer) to provide a logical view of the DFG revealing control and register data dependencies between instructions (i.e., inter-instruction dependencies). In some examples, the SDFG 110 stores a planar or spatially mapped view of the dataflow graph (indexed by position, out-of-order or indexed by two-dimensional coordinates) exposing its instruction-level parallelism. These two structures represent the same graph stored in different formats; the LDFG 108, being linear, is used to maintain instruction ordering, and the SDFG 110, being planar, is used to configure the spatial accelerator 104. Thus, the SDFG 110 can represent how instructions would be assigned to the accelerator 104. Additionally, the DFGs 108, 110 are weighted by measured latencies: nodes representing operations are weighted by nodes' execution latency (cycles from inputs ready to outputs produced), and edges representing connections are weighted by edges' data transfer latency (cycles from parent's output to child's input). The weighted DFG is used by the hardware controller 106 as a dynamic performance model based on runtime feedback 118 to estimate overall acceleration latency per iteration and rapidly identify the critical path and pinpoint nodes or edges that are sources of bottleneck. Using the performance model, a data-driven, locally latency-minimizing, and generally backend-agnostic hardware algorithm is used in the hardware controller 106 to map program instructions to spatial accelerators 104.

In some examples, the hardware controller 106 can monitor program execution on the CPU 102 to assess viability for acceleration. When a code region suitable for acceleration is detected, the hardware controller 106 performs three tasks: 1) encoding to build a LDFG from the code region queued for execution on the CPU core to unravel the structure and dependencies, 2) optimization to generate or build an SDFG using a hardware mapping algorithm, which locally minimizes each instruction's expected latency based on the LDFG and captured or estimated performance data as input, and 3) decoding to map the optimized SDFG to a programmable hardware backend with processing elements and load/store entries after which computation can be fully offloaded from the CPU.

In further examples, the hardware controller 106 provides an alternative, low-cost, and transparent method of utilizing existing accelerator hardware. Since the hardware controller 106 operates at runtime, the hardware controller 106 can use performance statistics gathered by activity counters on the CPU and accelerator to build a performance model of the target code region. With the model and statistics, the hardware controller 106 can use a data-driven instruction mapping algorithm that can iteratively optimize the accelerator configuration based on runtime feedback. In some examples, the hardware controller 106 may not include performance counters to build its performance model and perform accelerator mapping. In further examples, the availability of runtime statistics allows iterative optimization of the accelerator configuration, which can improve the spatial accelerator's efficiency in our experiments.

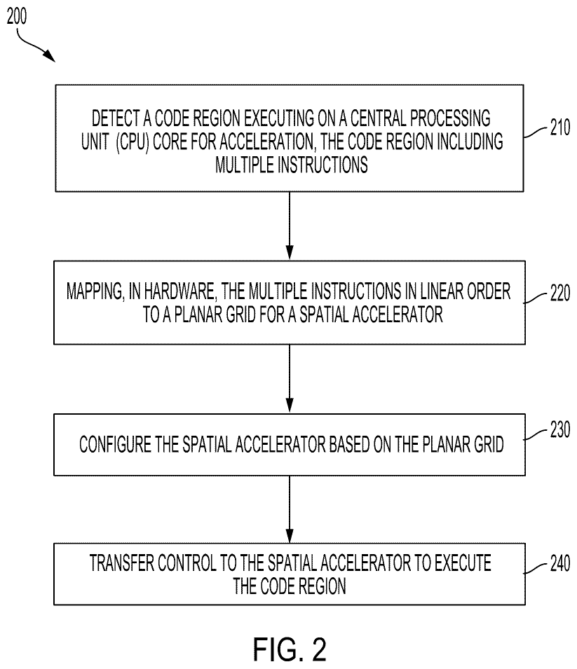

FIG. 2 is a flow chart illustrating an exemplary process for a dataflow-based general-purpose processor architecture in accordance with some aspects of the present disclosure. In some aspects of this disclosure, the example process 200 in FIG. 2 may be implemented by or with the hardware controller 106, one or more CPU cores 102, and/or any other suitable circuit to perform the example process 200 illustrated in and described with respect to FIG. 1. In other examples, the example process 200 can be performed by more than one hardware component. For example, the hardware controller 106 can be separate from CPU core(s) 102 and perform blocks 220 and 230 while blocks 210 and 240 can be performed by additional hardware on CPU cores. As described below, a particular implementation of the hardware controller may omit some or all illustrated features, and may not require some illustrated features to implement all embodiments.

In block 210, the hardware controller 106 detects a code region queued for executing on a central processing unit (CPU) core (e.g., the core 102) for acceleration. In some examples, the hardware controller 106 can monitor program execution on one or more CPU cores to assess viability for acceleration. In some examples, the code region can include multiple instructions. In some examples, an instruction can include an operation code to specify an operation to be performed. The operation to be performed can include an addition operation, a subtraction operation, a logical AND operation, a logical OR operation, a logical XOR operation, an increment operation, a decrement operation, or a logical NOT operation, or any other suitable computing operation. The instruction may also include or indicate one or more operands on which the specified operation is to be performed. The instruction may also indicate where a result of the operation may be stored (e.g., using a register identifier).

In some examples, the hardware controller 106 can store the code region in an instruction trace cache 130 at a frontend of the CPU core. In some examples, to detect the code region, the hardware controller 106 detects the code region satisfying at least one of multiple conditions based on the instruction trace cache. In some examples, the multiple conditions include: a first condition of whether the code region is a loop or a function that has fewer instructions than a maximum number of instructions supported by the spatial accelerator (i.e., valid loop detection), a second condition of whether the code region includes one or more unsupported instructions (i.e., instruction type check), a third condition of whether an iteration count in the code region is more than a preset threshold (i.e., instruction mix), and any other suitable condition depending on limitations of the specific accelerator used.

For the first condition (i.e., valid loop detection), the first condition is that the loop detected has fewer instructions than the maximum number of instructions supported by the accelerator. This is a preliminary check for structural hazards that will arise due to a lack of PEs and load-store entries. The loop's address range (start and end addresses) is recorded by the hardware controller's control registers.

For the second condition (i.e., control check), the hardware controller 106 enables instruction monitoring at the decode stage to identify unsupported instructions. In some examples, unsupported instructions can include system instructions (I/O access, system calls, etc.), backward jumps and branches to a target address within the loop (i.e., inner loops), and any instruction type not supported by the target accelerator's functional units (e.g., 64-bit operations on a 32-bit accelerator). In some examples, a violation invalidates the loop's candidacy for acceleration. In some examples, the second condition can be checked only when the first condition is met.

For the third condition (i.e., instruction mix), the hardware controller 106 tracks the number of compute and memory instructions relative to loop size because the loop might not necessarily yield promising speedup due to early exit or an unfavorable instruction mix. In some examples, the hardware controller 106 makes an estimate of the loop's expected iteration count based on the branch condition and program counter trace. These heuristics can be used because acceleration comes at a cost: evaluation results on the Rodinia benchmarks show that target loops typically execute 50-100 iterations to offset the initial cost of configuration and offloading. In some examples, the third condition can be checked only when the first and second conditions are met. However, it should be appreciated that at least one of the three conditions can be checked to detect the code region. In some examples, a loop passing all criteria (first, second, and third conditions) can still fail to generate an architecture configuration during the mapping process due to failure to route or other structural hazards. In some examples, the hardware controller 106 on the CPU core 102 can include an enhanced decode stage with instruction monitoring, an instruction trace cache, control registers, and/or some runtime data from branch units and load-store units.

In some examples, the hardware controller 106 can include the instruction trace cache 130 near an I-cache 132 to store only instructions that are within the code region targeted for acceleration. Instructions fetched from the I-cache are written to the trace cache if the addresses fall within the code region and were not already stored. In some examples, this trace cache can have a size equivalent to the maximum number of instructions that can be mapped on the accelerator (e.g., which may be 64-512 instructions). When the hardware controller 106 builds the LDFG, it accesses the trace cache without interfering with regular fetch on the CPU. If after many profiling iterations the hardware controller 106 is still missing some instruction(s) in its trace cache, the hardware controller 106 can temporarily stall the CPU's fetch stage to directly access the I-cache to retrieve missing instructions.

In block 220, the hardware controller 106 maps, in hardware, the multiple instructions in linear order to a planar grid for a spatial accelerator. In some examples, mapping in hardware indicates the mapping occurs inside the processor (e.g., the processor in the hardware controller 106 or one or more CPU cores 102) without any software involvement or changes. In some examples, the hardware controller 106 exploits, in hardware, a DFG model including a logical dataflow graph (LDFG) (e.g., the LDFG 108) and a spatial dataflow graph (SDFG) (e.g., the SDFG 110). Thus, the mapping for the LDFG and the physical and virtual SDFG occurs inside the processor and are in hardware without any software involvement. In some examples, the LDFG 108 and/or the SDFG 110 can be stored in a memory (e.g., static random-access memory (SRAM), dynamic random-access memory (DRAM), or any other suitable memory) in the hardware controller 106 or in the architecture 100.

In some examples, the hardware controller 106 uses the DFG model for instruction dependencies. In some examples, the DFG is a directed graph where instructions are represented by nodes, and dependencies between instructions are represented by edges. In some examples, each instruction i∈{i1, i2, . . . } has up to two predecessor instructions (source registers) s1, s2 whose outputs are its inputs. For example, if instruction i2 has a dependency on i1 (i.e., i2.s1=i1), then the DFG will have an edge (i1, i2) to denote that the output of instruction i1 is used as input for i2. We assign the weight of each node to be the average estimated or measured latency of the node's operation (cycles elapsed from inputs available to outputs produced), and we assign the weight of each edge as the average latency of data transfer (cycles elapsed from the output of source node to the input of destination node). For convenience, we introduce the following notations:
Lᵢ: cycle of completion of instruction i.
L_{(i, j)}: average latency of data transfer from i to j.
L_{i.op}: average latency of the operation of instruction i.

Under the dataflow model, an instruction can begin execution as soon as its inputs are available, regardless of original program order. In some examples, the latency Lᵢ of an instruction i can be defined as the number of cycles elapsed since the start of execution to the instruction's completion (i.e., the cycle at which the instruction produces its output). This latency can be given by the cycle at which its predecessors' data arrive (Aₛ₁, Aₛ₂) added by the latency of the instruction's operation (L_{i.op}):

$${L}_{i} = {L}_{i . o p} + max ( {A}_{s 1} , {A}_{s 2} ) , \qquad Equation 1$$

where max (Aₛ₁, Aₛ₂) gives the cycle the last input arrives at, since the operation cannot begin until all inputs are available. The cycle of data arrival Aₛ₁ can then be expanded as the latency of dependent instruction Lₛ₁ added by the latency of transfer from that instruction to the current L_{(s1,i)}. Thus, Equation 1 can be expanded as follows.

$${L}_{i} = {L}_{i . op} + max ( {\underbrace{{L}_{s 1} + {L}_{( s 1 , i )}}}_{Arrival cycle of S 1.} , {\underbrace{{L}_{s 2} + {L}_{( s 2 , i )}}}_{Arrival cycle of S 2.} ) \qquad Equation 2$$

Finally, the latency of an instruction sequence is the latency that all instructions are complete; this is given by the largest instruction latency: max{Lᵢ₁, Lᵢ₂, . . . }.

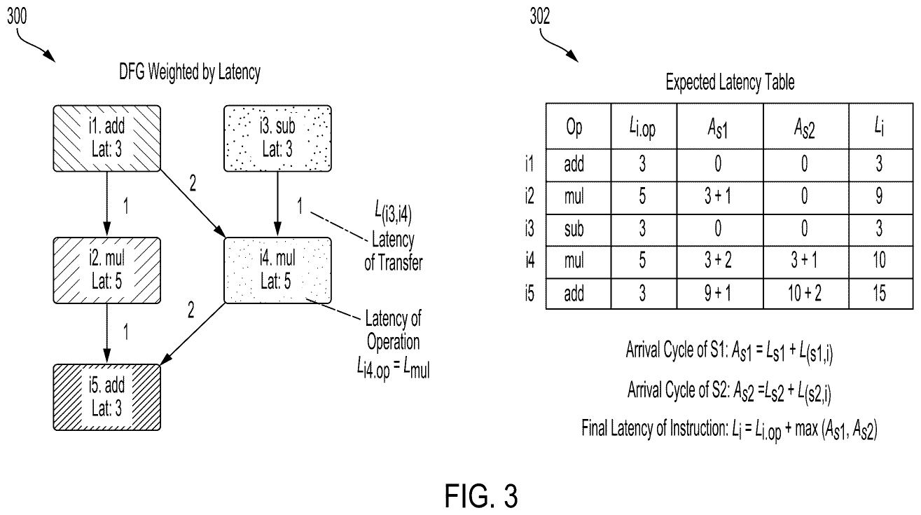

From the view of the DFG, the weight of a path is the sum of weights of nodes (operations) and edges (transfers) traversed; thus, the instruction latency Lᵢ is given by the path with largest weight (critical path) that ends at i. FIG. 3 shows an example DFG 300 with five instructions (i1-i5). In the example, initial inputs are already available from registers and that the latency of addition/subtraction is fixed at 3 cycles and multiplication takes 5 cycles. In some examples, the transfer latency between two nodes is modeled as the Manhattan distance between them, i.e., a single cycle for immediate neighbors and two cycles along the diagonal. FIG. 3 also shows a latency table 302 of each instruction in order. For example, instruction i1 has inputs immediately available, so its latency is simply the latency of addition (L_{add}=3). Instruction i2 only depends on i1's output (i2.s1=i1), which arrives after i1 completes plus a cycle of transfer (Aₛ₁=Lᵢ₁+L_{(i1,i2)}=3+1=4) and so its final latency including the five cycles of multiplication is Lₘᵤₗ+Aₛ₁=4+5=9. Filling the table using Equation 1 reveals that this code snippet takes 15 cycles to complete, with {i1, i4, i5} on the critical path. In the implementation, operation latencies L_{i.op} are generally stored as constants for immediate operations (add, mul, etc.) unless time-sharing of functional units or processing elements (PEs) is enabled or multiple types of arithmetic-logic unit (ALU) designs are used. Memory access operations are modeled by per-instruction average memory access time (AMAT), using counters at load/store unit entries. Data transfer latencies L_{(i,j}) are modeled based on the interconnect used, and measured cycles from counters at individual PEs if available.

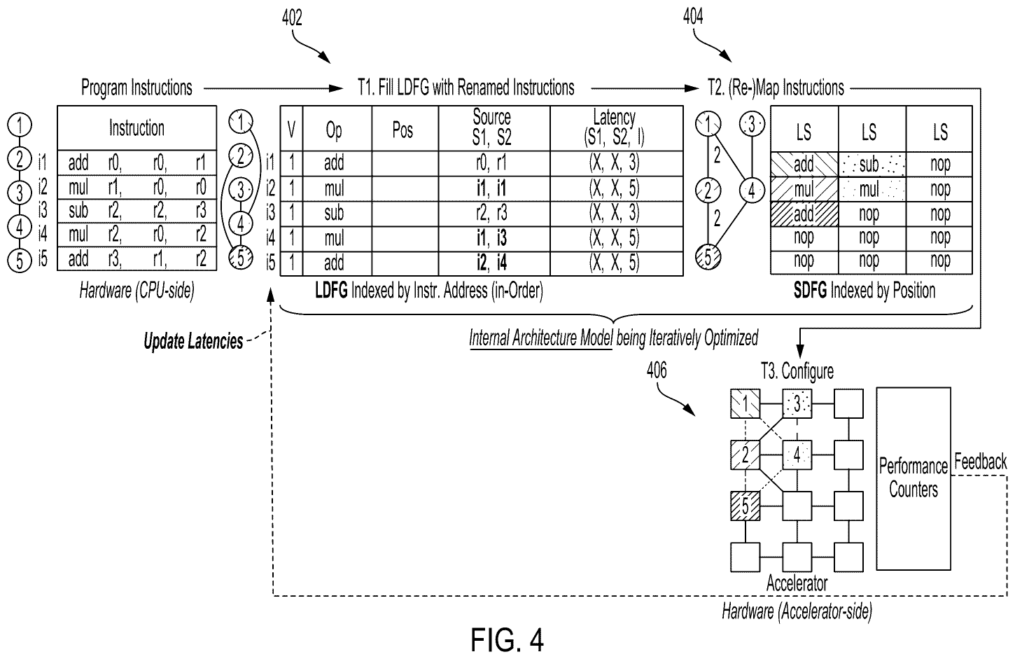

FIG. 4 shows how a hardware controller 106 builds and refines a DFG-based architecture model used to optimize and configure a target spatial accelerator. For example, the hardware controller 106 can perform three steps along with the data structures involved: step 1 (402): building the LDFG (an example of the LDFG 108) from instructions, step 2 (404): spatially mapping each instruction to form the SDFG (an example of the SDFG 110), step 3 (406): configuring the accelerator using the SDFG.

In some examples, to map the multiple instructions, the hardware controller 106 can build a logical dataflow graph (LDFG) indexed by multiple instruction addresses corresponding to the multiple instructions. In some examples, to build the LDFG, the hardware controller 106 can rename the multiple instructions to the multiple instruction addresses, generate multiple nodes in the LDFG corresponding to the multiple instruction addresses, generate one or more edges in the LDFG based on the multiple instruction addresses, and/or assign one or more operational latencies corresponding to one or more instructions of the multiple instructions to one or more nodes of the multiple nodes. In some examples, a node in the LDFG can indicate an instruction while an edge in the LDFG can indicate a dependency between two nodes. In some examples, to rename the multiple instructions, the hardware controller 106 can rename one or more source registers of a first instruction of the multiple instructions to one or more instruction addresses of the multiple instruction addresses in response to a child node of the multiple nodes. In some examples, a child node can include at least one source register, which is communicatively coupled to a destination register in a prior instruction in order. In some examples, instructions in order can indicate instructions are listed in order in the program or the code region. In some examples, the instructions are assigned and committed in program order but can be loaded out-of-order. In some examples, the hardware controller 106 can use architectural registers for a root node, which does not have any parent node. Thus, the hardware controller 106 can rename source registers of the root node to initially mapped architectural registers. In some examples, a rename table initially has all architectural registers mapped to one or more root nodes.

In some examples, to build the LDFG, the hardware controller 106 can generalize renaming in out-of-order cores: rather than renaming architectural registers to physical registers, the architectural registers can be renamed to instruction addresses. In other words, there are as many physical registers as instructions, which is true in the context of spatial accelerators where each PE produces its own output. Like the case for CPUs, a rename table can be used to hold a map of architectural registers to the last instruction that writes to it. In the simple example shown in FIG. 4, the first instruction i1 writes to destination register r0, thus r0 is mapped to i1 in the rename table. A subsequent instruction with r0 as source register will thus be replaced with i1. This is the case for shown for i2 in the example. Conceptually, the r0 data dependency is represented by an edge between i1 and i2 in the DFG. The LDFG can be built in this manner by simply renaming all instructions in order, and storing collected operation latencies if available. In the first LDFG build, data transfer latencies are not available since operations have not been mapped to the accelerator yet, but this becomes available after performing the mapping algorithm in step 2 (404) and in subsequent optimization attempts.

In some examples, to map the multiple instructions, the hardware controller 106 can build or further build a spatial dataflow graphs (SDFG) based on the LDFG. In some examples, the SDFG is indexed by multiple two-dimensional virtual coordinates of the planar grid. In some examples, the multiple two-dimensional virtual coordinates can correspond to the multiple instructions. In some examples, the SDFG can include: multiple nodes corresponding to the multiple instructions and one or more edges. In some examples, each node can be weighted by an operation latency of a respective instruction of the multiple instructions while each edge can be weighted by a data transfer latency between two nodes connected to the respective edge. In some examples, a node of the SDFG can indicate an instruction while an edge of the SDFG can indicate a dependency between two nodes of the SDFG. In further examples, the LDFG and the SDFG can be directed to the same DFG.

In some examples, to build the SDFG, the hardware controller 106 can generate a candidate matrix including multiple elements for a first instruction of the multiple instructions, determine multiple data transfer latencies from the one or more instructions for a subset of the multiple elements in the candidate matrix, and assign the first instruction to a first element of the subset of the multiple elements. In some examples, the subset of the multiple elements corresponds to the one or more instructions used as source in the first instruction. In some examples, the planar grid includes the candidate matrix. In some examples, the first element can have a minimum data transfer latency of the multiple data transfer latencies. In further examples, to determine the multiple data transfer latencies from the one or more instructions, the hardware controller 106 filters out one or more unavailable elements from the plurality of elements in the candidate matrix, and determines the multiple data transfer latencies from the one or more instructions for the subset. In some examples, the subset of the multiple elements corresponds to one or more elements filtering out the one or more unavailable elements from the multiple elements. Thus, the one or more elements can be remaining element(s) after filtering out the one or more unavailable elements from the multiple elements. In further examples, the multiple data transfer latencies from one or more instructions are determined by a measured latency (e.g., an actual latency) or a mathematically modelled latency (e.g., an estimated latency) of data transfer between the first instruction and the one or more instructions configured on the spatial accelerator. In further examples, the candidate matrix includes an equidistant rectangle matrix enclosing the one or more instructions. In some examples, the hardware controller 106 can update the LDFG based on the minimum data transfer latency between the first element and the one or more instructions, and optimize the SDFG based on the updated LDFG.

In some examples, the instruction mapping algorithm can convert the LDFG to SDFG by assigning each instruction to a coordinate as shown in step 2 (404) of FIG. 4. The algorithm has a goal of minimizing each instruction's latency as defined in Equation 1. With the DFG performance model available, the latency of an instruction depends solely on the latency of its predecessor with a higher latency (which necessarily lies on the critical path), thus minimizing the transfer latency of this critical path should be of high priority during mapping.

While there is no strict standard, most spatial accelerators today use a dense 2D grid of PEs that are locally connected to their immediate neighbors and globally connected through a shared interconnect to distant units and memories. However, the hardware controller 106 does not restrict the type of interconnect used in the backend as long as it can model the point-to-point communication latency between two PEs. In some examples, a matrix F can be used to represent the placement of instructions in a grid of available functional units (PEs), e.g., assigning Fᵢⱼ=i2 means instruction i2 is placed at the PE with virtual coordinate (i, j). The initial state of F is a zero matrix denoting all nops. In some examples, the term ‘virtual’ can be used since the coordinates here are only used for the spatial DFG model, and will eventually be converted to physical addresses during the configuration step 406. In further examples, a free matrix F_{free} can be tracked. The free matrix F_{free} is a binary matrix with the same dimensions as F that keeps track of instruction occupancy. The instruction occupancy can represent the availability of PEs. This is the two-dimensional analog to the register free list for renaming in out-of-order processors. In the case that not all PEs support all operations, a constant masking matrix Fₒₚ for each operation can be element-wise multiplied (AND) to F_{free} to filter out all occupied or unsupported PEs for the current operation.

Algorithm 1: Instruction mapping by minimizing latency

```
// Iterate over instructions in LDFG
foreach i ∈ {i0, i1, i2, ... } do
  s1 ← i.s1;
  s2 ← i.s2;
  Cᵢ ← GenerateCandidateMatrix(i, s1, s2);
  // Filter out unavailable positions
  Cᵢ ← Cᵢ ⊙ C_{free} ⊙ C_{i.op}
  minLatency ← ∞ minPosition ← (−1, −1);
  // Determine latency of candidates
  foreach c ∈ Cᵢ do
    if c ≠ 0 then
      Aₛ₁ ← Lₛ₁ + L_{(s1,c)};
      Aₛ₂ ← Lₛ₂ + L_{(s2,c)};
      expLatency ← L_{i.op} + max(Aₛ₁, Aₛ₂);
      if expLatency < minLatency then
        minLatency ← expLatency;
        minPosition ← c.pos;
      end
    end
  end
  // Map to latency minimizing position
  i.pos ← minPosition
end
```

Algorithm 1 shows an instruction mapping algorithm that may be used by the hardware controller 106. For each instruction i to be mapped, we consider a candidate matrix Cᵢ (a submatrix of F) including nearby positions of its dependents i.s1 and i.s2. For example, for a standard two-dimensional mesh interconnect where latency can be modeled by the Manhattan distance, the candidate submatrix can be defined as the equidistant rectangle enclosed by its predecessors as follows.

$${C}_{i} = {F}_{[ s {1}_{x} , … , s {2}_{x} ; s {1}_{y} , … , s {2}_{y} ]} \qquad Equation 3$$

In some hardware implementation examples, due to the large size of F, the candidates can be determined from the binary free matrix Cᵢ=(F_{free}⊙Fₒₚ)_{[s1}_{ₓ}_{, . . . ,s2}_{ₓ}_{;s1}_{_{y}}_{, . . . ,s2}_{_{y}}_{]}, which is a matrix of single bits that can be rapidly accessed. In other words, F_{free} zeroes (filters out) positions that are already occupied, and Fₒₚ zeroes positions where the PE is incompatible (does not support the current operation). The Fₒₚ matrices for different operations are predetermined based on the specifications of the hardware backend. In some algorithm implementation examples, due to constraints, Cᵢ can be a fixed 4×8 matrix positioned based on the predecessor with higher latency. In some examples, a latency matrix I(Cᵢ) can be defined where each element is the instruction's latency Lᵢ if the instruction is placed at the corresponding element location. Finally, the instruction can be assigned to the latency minimizing position I(Cᵢ). If multiple positions have equal latency, in some examples, positions can be prioritized with more free entries in its local neighborhood.

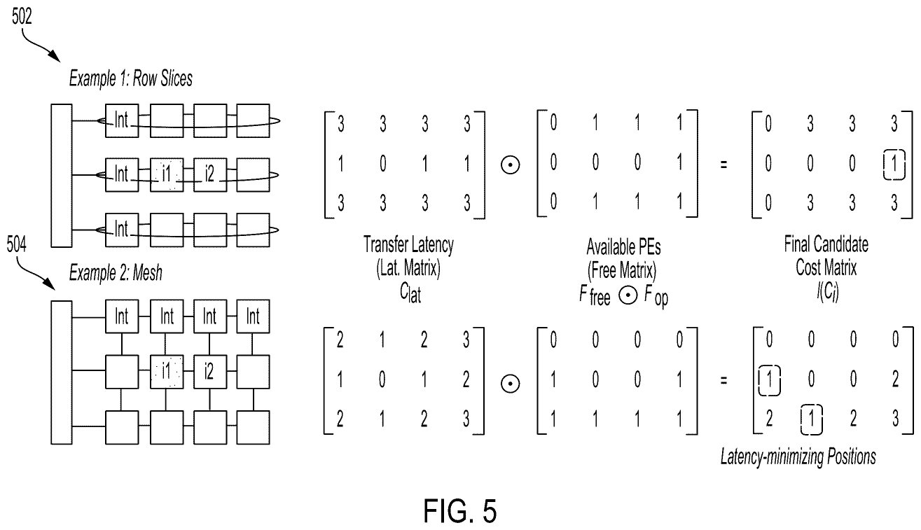

FIG. 5 is an illustration of dependent instruction placement examples. Examples 1 (502) and 2 (504) are examples about how to place i, which depends on i1 as input after i1 and i2 has already been placed. In Example 1 (502), the hierarchical interconnect has a 3-cycle data transfer latency across rows but a 1-cycle latency within a row. In Example 2 (504), latency is given by the Manhattan distance. Occupied PEs are filtered out by F_{free} and incompatible PEs are filtered out by Fₒₚ. The same instruction snippet as FIG. 4 is used such that i is a floating-point (FP) multiply that only depends on i1. The latency function here is simplified to just be the data transfer latency L_{(i1,i4)} since Lᵢ₁ is constant and two types of backend interconnects are demonstrated. In Example 1 (502), a hierarchical interconnect of row slices allows point-to-point single-cycle latency between PEs in the same row and a fixed 3-cycle latency across rows. In Example 2 (504), a mesh interconnect has latency equivalent to the Manhattan distance between two points on the grid. The matrices Fₒₚ filter out integer PEs that are incompatible, and F_{free} filters out positions already occupied by i1 and i2. Finally, the instruction i4 is placed at a valid (nonzero) position with the smallest cost value.

In some examples, the hardware controller 106 can perform spatial mapping and does not time-schedule PEs with multiple instructions. Additionally, the hardware controller 106 performs mapping in a single pass without backtracking. In some examples, a secondary bus or interconnect can be used as a fallback so that instructions that failed to be mapped can revert back to a slower but less restrictive data forwarding mechanism. In terms of backend architecture support, the hardware controller 106 can use two main components: an operation masking matrix Fₒₚ provided for each type of operation that indicates which PEs support the operation and a hardware-implementable function I(C) that computes the latency of each position given the current mapping. In other words, the interconnect can be easily modeled such that the latency between any two points can be rapidly calculated. In further examples, the hardware controller 106 reduces the complexity of each step due to hardware constraints. For each instruction, the hardware controller 106 gathers a set of candidate PEs available to assign, uses some cost metric (i.e., latency) to enforce an ordering on these candidates, and finally, makes a placement decision based on all available information. The hardware controller 106 has a DFG model based on real-time latency data that grants confidence to placement decisions in reflecting actual performance.

Referring again to FIG. 2, in block 230, the hardware controller 106 configures the spatial accelerator based on the planar grid. In some examples, to configure the spatial accelerator 104, the hardware controller 106 can map multiple virtual coordinates of the planar grid (e.g., of the SDFG 110) to multiple physical processing elements (PEs) of the spatial accelerator 104.

In some examples, the hardware controller 106 configures the spatial accelerator by mapping the SDFG 110 to physical PEs and configuring its interconnect in the process. For examples, multiplexers in the interconnect can be configured based on the SDFG 110. Graph nodes can be used to configure physical PEs while graph edges can be used to configure physical interconnect. In some examples, the SDFG 110 built by Algorithm 1 is already indexed by coordinate with all parent-to-child connections. In some examples, a configuration manager of the hardware controller 106 iterates through the SDFG 110 and sends operation and interconnect control bits (a configuration bitstream) to the accelerator 104. Thus, this can be virtual to physical mapping as operations assigned to virtual coordinates in the SDFG 110 are mapped to physical locations in hardware. Most PEs are locally connected to their immediate neighbors. Since the hardware controller 106 does not time-multiplex PEs, accelerator configuration can be done once per code region unless the hardware controller 106 finds a better mapping in subsequent iterations. Finally, a configuration cache is stored on the hardware controller 106 for loops that have already been mapped in case they are re-encountered in the near future. In further examples, the LDFG 108 and the SDFG 110 built in block 220 can be used without considering the types of the spatial accelerator, and the configuration step in block 230 can consider the specific type of the spatial accelerator 104 to map the SDFG 110 to physical PEs in the accelerator 104.

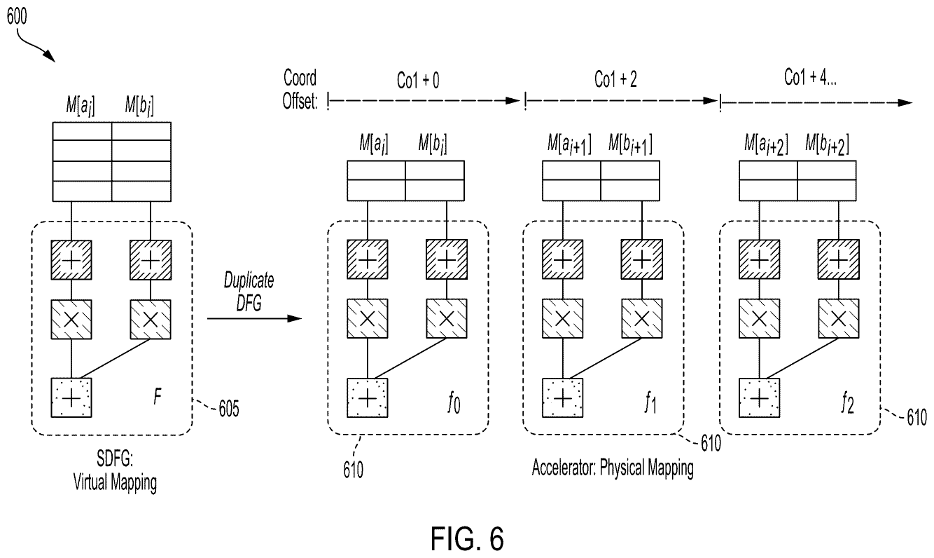

In some examples, if a loop is known to be parallelizable without inter-iteration dependencies, the hardware controller 106 can use more advanced loop-level optimizations. As the hardware controller 106 does not speculate at the thread level, this scenario can apply to pre-annotated programs (e.g., with OpenMP). In some examples, the hardware controller 106 can support the pragmas “omp parallel” and “omp simd” directives where iterations are fully parallelizable without critical sections. FIG. 6 includes a diagram 600 showing that spatial tiling can be performed during the configuration step by subgraph duplication, and each instance can independently execute in parallel. In some examples, instances of the same (virtual) SDFG 605 can be fully duplicated when configuring the spatial accelerator 104. Tiling the loop in this manner allows independent DFGs 610 to execute concurrently on the accelerator 104 to improve throughput. Additionally, loop pipelining can also be enabled if supported by the hardware.

Referring again to FIG. 2, in block 240, the hardware controller 106 transfers control to the spatial accelerator 104 to execute the code region. Thus, the hardware controller 106 can offload computational tasks of the instructions in the code regions to the spatial accelerator 104. Because the hardware controller 106 is a DFG equipped abstraction layer, the hardware controller 106 can be a generalizable solution portable to different accelerator variants.

In some examples, the hardware controller's handling of memory accesses depends heavily on the architecture of the spatial accelerator. In the DFG model of the hardware controller 106, memory accesses are abstracted as a node with variable latency. If per-instruction performance counters are available at load-store units, this latency can accurately reflect its average memory access time. Depending on the accelerator's memory subsystem, there are several optimizations that may be implemented.

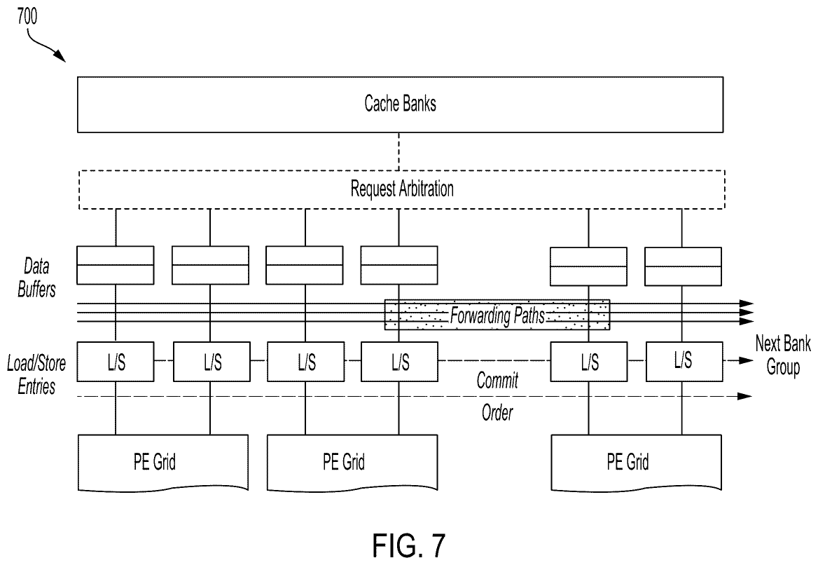

For example, if the accelerator uses traditional load-store queues that enforce ordering (e.g., shared with CPU), memory disambiguation can be performed in much the same way as out-of-order cores. To improve performance, the custom accelerator used for evaluation can be equipped with a more advanced load-store unit that uses the already-built LDFG for ordering and allows data forwarding. FIG. 7 shows memory load-store entries connected to PEs (this figure is illustrative only, the actual design has far more entries sharing a port). In some examples, the LDFG maintains the sequence of instructions in original program order because memory instructions can be assigned and committed (final stores) in original order. However, individual loads can be performed out-of-order as soon as their addresses are generated. Much like load-store queues (LSQs), a load can be invalidated if a prior store instruction commits and matches its address. This invalidation forces the new value to propagate through the remainder of the DFG as if the load had initially been completed.

In some examples, extraneous store-load pairs to the same addresses can be detected as they have the same address register and offset. Such pairs become a direct forwarding path (an edge in the DFG), thereby eliminating redundant accesses. Forwarding paths shown in FIG. 7 allow direct memory data forwarding through data broadcast to identify matching store-load pairs at runtime, eliminating subsequent accesses to the same address.

In some examples, when the hardware controller 106 builds the LDFG, it tracks changes to the base address register of memory instructions via the rename table as registers are renamed each time they are updated. Load accesses sharing the same (unchanged) base address register with different offsets can be vectorized. Additionally, loads whose base address registers depend only on induction registers can be speculatively prefetched an iteration ahead.

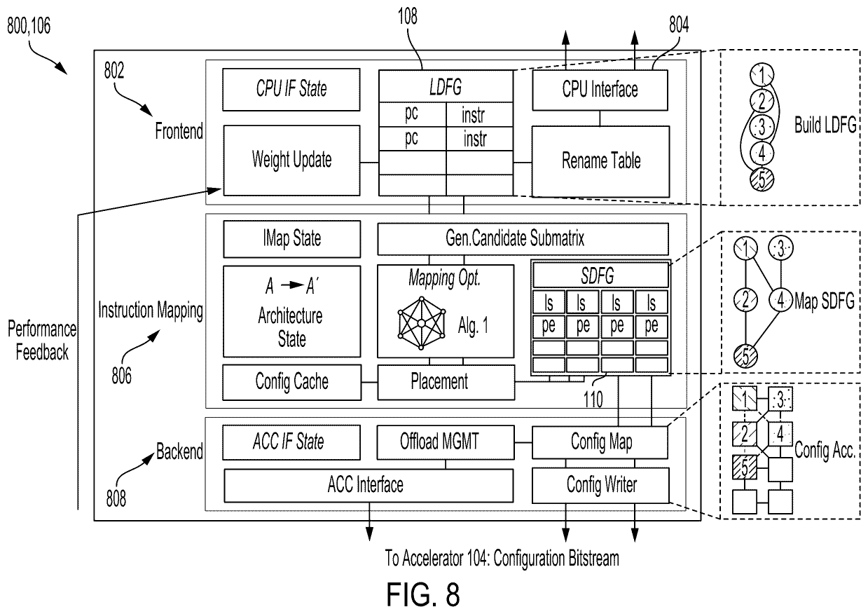

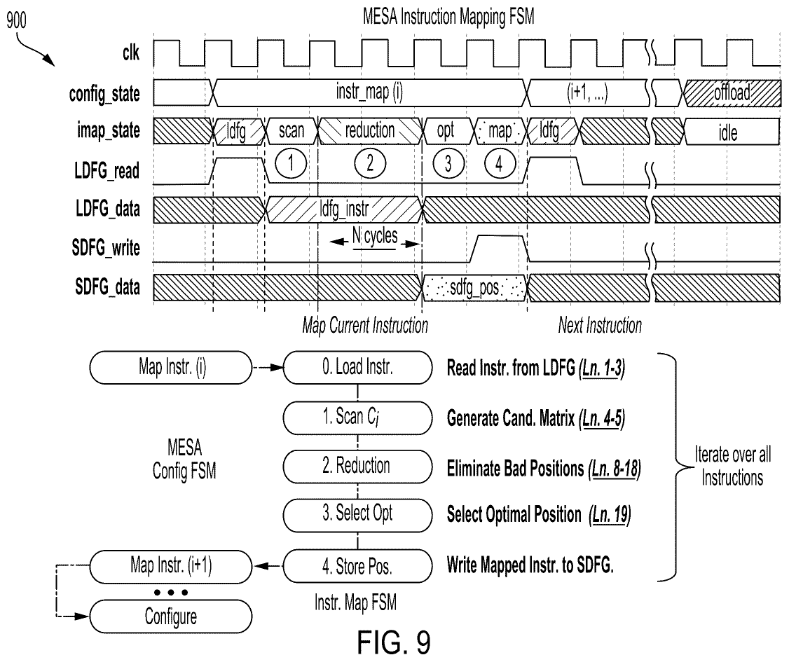

FIG. 8 is an illustration of an architecture 800 of a hardware controller, according to some examples. In some examples, the hardware controller 106 can be implemented (e.g., in synthesizable System Verilog) according to the architecture 800. Accordingly, the architecture 800 of FIG. 8 may also be referred to as the hardware controller 106 itself. A frontend 802 of the hardware controller 106 includes a CPU interface 804 that interfaces with the CPU (e.g., CPU core(s) 102) and may be responsible for renaming instructions from the instruction trace cache and building the LDFG. Once built, the instruction mapping process can begin (see instruction mapping functional block 806). For example, instructions are accessed in order from the LDFG and mapped to the SDFG according to Algorithm 1. Referring to FIG. 9, a timing diagram 900 of instruction mapping stages (e.g., in the imap (InstrMap) state machine) is illustrated. In some examples, the actions of each state are matched with tasks performed in lines of Algorithm 1. In some examples, the number of cycles for the reduction stage can depend on the dimensions of the candidate matrix while all other states are constant. The imap FSM loops until all instructions in the LDFG are mapped to the SDFG. Once the SDFG has been built, the configuration block of the hardware controller 106 sequentially writes instructions and routing configuration bits to the spatial accelerator 104.

In some examples, the hardware controller 106 can be interfaced with the CPU 102 (e.g., the RISC-V BOOM core under the Chipyard framework) with a custom interface to test for control transfer and offloading. In general, the hardware controller 106 does not negatively interfere with the regular execution of the CPU 102. When a valid code region is detected, the CPU 102 continues executing normally as the hardware controller 106 collects instructions and data from performance counters, if available, to construct the LDFG. When the spatial accelerator 104 is configured, the CPU 102 is allowed to complete its current iteration but is halted when PC reaches the entry point of the accelerated loop or function again; at this point, the hardware controller 106 awaits all in-flight instructions in the pipeline to commit and transfer control to the spatial accelerator 104 along with the current architectural state (register file, status registers, etc.). During acceleration, the CPU 102 awaits a return signal from the hardware controller 106, and the hardware controller 106 can context switch in the meantime. When acceleration completes (program counter (PC) reaches outside the loop region), control is transferred back to the CPU 102 along with the architectural state and a return instruction address from which the CPU 102 resumes much like a subroutine return.

The architecture 800 further includes a backend 808. The backend 808 may include a programmable hardware backend with processing elements and load/store entries. The backend 808 may map the optimized SDFG 110 (e.g., to the processing elements and load/store entries), after which computation can be fully offloaded from the CPU (e.g., to the spatial accelerator 104).

A custom parameterizable spatial accelerator (e.g., the spatial accelerator 104) was developed specifically to test various aspects of, and enable end-to-end hardware evaluation of, two backend configurations of the backend 808 including: the hardware controller 106 with 128 PEs (M-128) arranged with grid dimension 16×8, of which half are equipped with single-precision floating-point logic; and the hardware controller 106 with 512 PEs (M-512), arranged in a 64×8 grid and 64 PEs (M-64) with a 16×4 grid. These dimensions were chosen after evaluating mapping outcomes on different loops.

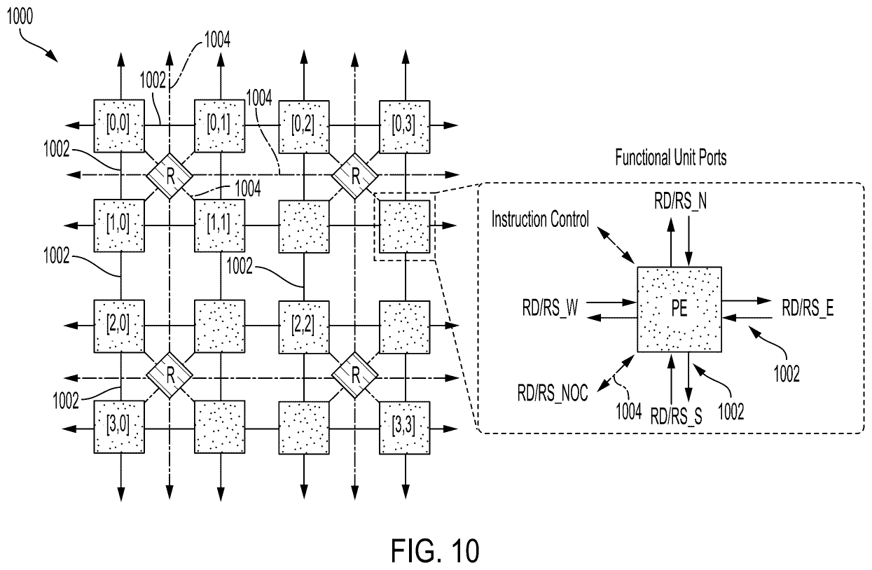

The spatial accelerator 104 uses a hierarchy of execution grids composed of locally-connected functional units arranged geometrically in a 2D mesh. As shown in FIG. 10, the accelerator 104 has two types of interconnects: local PE-to-PE connections 1002, and a lightweight network-on-chip (NoC) 1004 which is simply a half-ring interconnect with routing logic at every four PEs, which is called as a slice. The transfer latency from a functional unit to its immediate neighbors using direct PE-PE connections 1002 is a single cycle. Sending via the NoC 1004 takes longer depending on traffic and distance but allows long-distance transfers. These two interconnects can be used because a poor mapping generated by the hardware controller 106 may result in wasted PEs cycles waiting for data from its parents. The dataflow graphs of loop bodies targeted by the hardware controller 106 are strictly acyclic since the hardware controller 106 does not support nested loops in some examples. This means that a mapped loop always has data traveling in a feedforward (topological) fashion from source to destination register; hence each horizontal and vertical lane of the NoC 1004 can simply operate like a bus, avoiding possible deadlocks.

In some examples, the hardware controller 106 can support forward branches in the accelerated code region with or without speculation. In some examples, instructions under a branch region carry a hidden dependency on the previous instruction producing its destination register, i.e., the instruction previously mapped by the register rename table. This is desirable because, unlike the case for CPUs, disabled PEs can still forward the old register's value as there is no centralized register file. A control unit on the accelerator 104 can use the enabled signal of individual PEs. When a branch is taken, the PEs of all instructions skipped can be selectively disabled. In some examples, for backward branches or jumps resulting in inner loops, the hardware controller 106 can unroll the instructions by the compiler ahead of time or indicate that the loop is disqualified.

In some examples, simple latency counters can be placed at PEs and load-store entries on the accelerator 104 to count the start and end cycles of an operation. In some examples, the hardware controller's DFG model can store node and edge weights, hence these counters track per-instruction latency rather than an averaged instruction per cycle/clock (IPC) or an average memory access time (AMAT) estimate. These results are reported back to 's frontend where latencies are tallied and used to refine the hardware controller's DFG model and used as inputs for future optimization iterations.

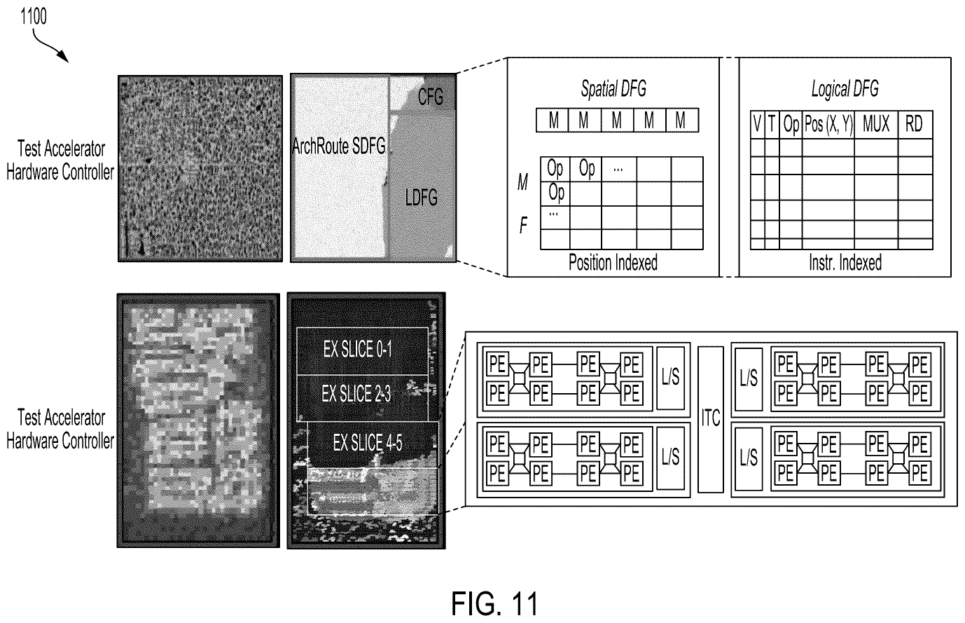

FIG. 11 is an illustration of example hardware synthesis 1100 of the hardware controller 106 and a custom spatial accelerator (e.g., the spatial accelerator 104). In some examples, the hardware design can be synthesized (e.g., using Synopsys Design Compiler (R-2020.09-SP4) with a FreePDK 15 nm open cell library). Then, preliminary place and route of the synthesized design can be performed (e.g., using Synopsys IC Compiler (L-2016.03-SP1)) for more accurate area and power estimations. Timing for extensions to the CPU is met at 2.0 GHz, however, the hardware controller 106 does not necessarily share the CPU core clock domain. Table 1 details hardware area and power breakdown by component for some examples. More particularly, the top third of Table 1 shows a hardware area and power consumption breakdown of main components in the hardware controller 106. In some examples, area and power are primarily by the hardware data structures that store the DFG. The middle part of Table 1 shows the total area and power of additional microarchitectural structures to be added to CPU cores for monitoring. The bottom part of Table 1 shows estimates for the custom spatial accelerator used for evaluation. Overall, the overhead of integrating is relatively small at 0.5 mm² with negligible per-core additions given that accelerator-integrated SoCs are targeted. Furthermore, only one hardware controller can be used per chip to interface with all cores unless multiple accelerators are explicitly and simultaneously configured.

Table 1: Hardware area and power breakdown by component. Synthesis results from Synopsys DC. This table shows a configuration with 128 PEs. (*) Synthesized to register arrays due to lacking SRAM cells. (**)

TABLE 1
Hardware area and power breakdown by component.
Synthesis results from Synopsys DC. This table
shows a configuration with 128 PEs.

| | Area | | Power | |
|---|---|---|---|---|
| Hardware Controller Extensions | | | | |
| Hardware Controller Top | 0.502 | mm² | 0.36 | W |
| \|- Hardware Controller ArchModel | 0.375 | mm² | 0.27 | W |
| \|- Instr. RenameTable | 11417.5 | μm² | 6.161 | mW |
| \|- LDFG* | 148483.6 | μm² | 0.09 | W |
| \|- Instr. Convert | 601.4 | μm² | 0.465 | mW |
| \|- Instr. Mapping | 208432.9 | μm² | 0.13 | W |
| \|- Latency Optimizer | 4060.4 | μm² | 3.302 | mW |
| \|- SDFG | 201171.0 | μm² | 0.12 | W |
| \|- Hardware Controller ConfigBlock | 101357.9 | μm² | 0.07 | W |
| CPU Core Additions | | | | |
| Trace Cache | 27124.5 | μm² | 15.455 | mW |
| Controller Interface | 3590.1 | μm² | 3.219 | mW |
| Spatial Accelerator | | | | |
| Accelerator Top | 26.56 | mm² | 11.65 | W |
| \|- PE Array | 14.95 | mm² | 4.08 | W |
| \|- FP Slice (2 × 2) | 821889.1 | μm² | 213.107 | mW |
| \|- PE (FP/INT) | 204965.6 | μm² | 52.229 | mW |
| \|- INT Slice (2 × 2) | 10415.2 | μm² | 18.186 | mW |
| \|- PE (INT) | 2337.5 | μm² | 3.044 | mW |

*Synthesized to register arrays due to leaking SRAM cells. (**)

The performance and energy efficiency of the architecture using the hardware controller 106 were evaluated using benchmarks from the Rodinia benchmark suite against a 16-core quad-issue out-of-order RISC-V CPU simulated in gem5 (based on BOOM as the baseline core). On average, the architecture using the hardware controller 106 achieved 1.33× and 1.81× performance gains across all benchmarks for the two configurations. In terms of energy efficiency, the architecture using the hardware controller 106 (i.e., M-128 and M-512) averaged 1.86× and 1.92× improvement over the CPU respectively.

Accordingly, in some examples, to unlock transparent acceleration for general-purpose processors, the architecture using the hardware controller 106 developed a new method for dynamic binary translation targeting spatial accelerators. The hardware controller 106 can extend the CPU's microarchitecture to profile the running application and build a DFG-based model that allows it to model both functionality and performance. Then, a data-driven instruction mapping algorithm can be introduced where the algorithm targets spatial architectures that is low latency and cost-effective when implemented in hardware. The implementation shows that the hardware controller 106 uses relatively low area and power investments to add this functionality to the CPU core, and simulation results show promising speedup and efficiency gains. Compared to past works in DBT, the hardware controller 106 finds a balanced middle ground between rapid configuration time and optimization level. A system-on-chip with the hardware controller 106 integrated grants running applications the potential to utilize idle accelerator resources with full transparency. This also allows the accelerator to operate solely in hardware without specialized code or compilers, similar in vein to out-of-order execution in hardware but beyond just instruction-level parallelism. Furthermore, the hardware controller 106 maintains an internal architecture and performance model of the accelerator, which can be continuously refined.

The present disclosure uses the term “aspects” does not require that all aspects of the disclosure include the discussed feature, advantage or mode of operation. The present disclosure uses the term “coupled” to refer to a direct or indirect coupling between two objects. For example, if object A physically touches object B, and object B touches object C, then objects A and C may still be considered coupled to one another—even if they do not directly physically touch each other. For instance, a first object may be coupled to a second object even though the first object is never directly physically in contact with the second object. The present disclosure uses the terms “circuit” and “circuitry” broadly, to include both hardware implementations of electrical devices and conductors that, when connected and configured, enable the performance of the functions described in the present disclosure, without limitation as to the type of electronic circuits, as well as software implementations of information and instructions that, when executed by a processor, enable the performance of the functions described in the present disclosure.

One or more of the components, steps, features and/or functions illustrated in FIGS. 1-11 may be rearranged and/or combined into a single component, step, feature or function or embodied in several components, steps, or functions. Additional elements, components, steps, and/or functions may also be added without departing from novel features disclosed herein. The apparatus, devices, and/or components illustrated in FIGS. 1-11 may be configured to perform one or more of the methods, features, or steps described herein. The novel algorithms described herein may also be efficiently implemented in software and/or embedded in hardware.

It is to be understood that the specific order or hierarchy of steps in the methods disclosed is an illustration of exemplary processes. Based upon design preferences, it is understood that the specific order or hierarchy of steps in the methods may be rearranged. The accompanying method claims present elements of the various steps in a sample order, and are not meant to be limited to the specific order or hierarchy presented unless specifically recited therein.

Applicant provides this description to enable any person skilled in the art to practice the various aspects described herein. Those skilled in the art will readily recognize various modifications to these aspects, and may apply the generic principles defined herein to other aspects. Applicant does not intend the claims to be limited to the aspects shown herein, but to be accorded the full scope consistent with the language of the claims, wherein reference to an element in the singular is not intended to mean “one and only one” unless specifically so stated, but rather “one or more.” Unless specifically stated otherwise, the present disclosure uses the term “some” to refer to one or more. A phrase referring to “at least one of” a list of items refers to any combination of those items, including single members. As an example, “at least one of: a, b, or c” is intended to cover: a; b; c; a and b; a and c; b and c; and a, b and c. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

What is claimed is:

1. A method for translation and optimization for acceleration, comprising:
detecting a code region queued for executing on a central processing unit (CPU) core for acceleration, the code region comprising a plurality of instructions;
mapping, in hardware, the plurality of instructions in linear order to a planar grid for a spatial accelerator;
configuring the spatial accelerator based on the planar grid; and
transferring control to the spatial accelerator to execute the code region.

2. The method of claim 1, further comprising:
storing the code region in an instruction trace cache at a frontend of the CPU core.

3. The method of claim 2, wherein the detecting of the code region comprises: detecting the code region satisfying at least one of a plurality of conditions based on the instruction trace cache,
wherein the plurality of conditions comprises:
a first condition of whether the code region is a loop or a function that has fewer instructions than a maximum number of instructions supported by the spatial accelerator,
a second condition of whether the code region includes one or more unsupported instructions, and
a third condition of whether an iteration count in the code region is more than a preset threshold.

4. The method of claim 1, wherein the mapping of the plurality of instructions comprises:
building a spatial dataflow graph (SDFG), the spatial dataflow graph comprising a plurality of nodes corresponding to the plurality of instructions and one or more edges, each node weighted by an operation latency of a respective instruction of the plurality of instructions, each edge weighted by a data transfer latency between two nodes connected to the respective edge.

5. The method of claim 1, wherein the mapping of the plurality of instructions comprises:
building a logical dataflow graph (LDFG) indexed by a plurality of instruction addresses corresponding to the plurality of instructions; and
building a spatial dataflow graph (SDFG) based on the LDFG, the SDFG being indexed by a plurality of two-dimensional virtual coordinates of the planar grid, the plurality of two-dimensional virtual coordinates corresponding to the plurality of instructions.

6. The method of claim 5, wherein the building of the LDFG comprises:
renaming the plurality of instructions to the plurality of instruction addresses;
generating a plurality of nodes in the LDFG corresponding to the plurality of instruction addresses;
generating one or more edges in the LDFG based on the plurality of instruction addresses; and
assigning one or more operational latencies corresponding to one or more instructions of the plurality of instructions to one or more nodes of the plurality of nodes.

7. The method of claim 6, wherein the renaming of the plurality of instructions comprises:
in response to a child node of the plurality of nodes, renaming one or more source registers of a first instruction of the plurality of instructions to one or more instruction addresses of the plurality of instruction addresses.

8. The method of claim 5, wherein the building of the SDFG comprises:
generating a candidate matrix for a first instruction of the plurality of instructions, the candidate matrix comprising a plurality of elements, a subset of the plurality of elements corresponding to one or more instructions used as source in the first instruction, the planar grid comprising the candidate matrix;
determining a plurality of data transfer latencies from the one or more instructions for the subset of the plurality of elements; and
assigning the first instruction to a first element of the subset of the plurality of elements, the first element having a minimum data transfer latency of the plurality of data transfer latencies.

9. The method of claim 8, wherein the determining of the plurality of data transfer latencies from the one or more instructions comprises:
filtering out one or more unavailable elements from the plurality of elements in the candidate matrix, the subset of the plurality of elements corresponding to one or more elements filtering out the one or more unavailable elements from the plurality of elements; and
determining the plurality of data transfer latencies from the one or more instructions for the subset.

10. The method of claim 8, wherein the plurality of data transfer latencies from one or more instructions is determined by a measured latency or a mathematically modelled latency of data transfer between the first instruction and the one or more instructions configured on the spatial accelerator.

11. The method of claim 8, wherein the candidate matrix comprises an equidistant rectangle matrix enclosing the one or more instructions.

12. The method of claim 8, further comprising:
updating the LDFG based on the minimum data transfer latency between the first element and the one or more instructions; and
optimizing the SDFG based on the updated LDFG.

13. The method of claim 1, wherein the configuring of the spatial accelerator comprises:
mapping a plurality of virtual coordinates of the planar grid to a plurality of physical processing elements of the spatial accelerator.

14. A circuit comprising:
a memory comprising: a spatial dataflow graph, and
a control circuit coupled to the memory, the control circuit configured to:
detect a code region queued for executing on a central processing unit (CPU) core for acceleration, the code region comprising a plurality of instructions;
map in hardware the plurality of instructions in linear order to a planar grid of the spatial dataflow graph for a spatial accelerator;
configure the spatial accelerator based on the planar grid; and
transfer control to the spatial accelerator to execute the code region.

15. The circuit of claim 14, wherein the control circuit is further configured to:
store the code region in an instruction trace cache at a frontend of the CPU core.

16. The circuit of claim 15, wherein to detect of the code region, the control circuit is configured to: detect the code region satisfying at least one of a plurality of conditions based on the instruction trace cache,
wherein the plurality of conditions comprises:
a first condition of whether the code region is a loop or a function that has fewer instructions than a maximum number of instructions supported by the spatial accelerator,
a second condition of whether the code region includes one or more unsupported instructions, and
a third condition of whether an iteration count in the code region is more than a preset threshold.

17. The circuit of claim 14, wherein to map the plurality of instructions, the control circuit is configured to:
build a spatial dataflow graph (SDFG), the spatial dataflow graph comprising a plurality of nodes corresponding to the plurality of instructions and one or more edges, each node weighted by an operation latency of a respective instruction of the plurality of instructions, each edge weighted by a data transfer latency between two nodes connected to the respective edge.

18. The circuit of claim 14, wherein to map the plurality of instructions, the control circuit is configured to:
build a logical dataflow graph (LDFG) indexed by a plurality of instruction addresses corresponding to the plurality of instructions; and
build a spatial dataflow graph (SDFG) based on the LDFG, the SDFG being indexed by a plurality of two-dimensional virtual coordinates of the planar grid, the plurality of two-dimensional virtual coordinates corresponding to the plurality of instructions.

19. The circuit of claim 18,
wherein to build the LDFG, the control circuit is configured to:
rename the plurality of instructions to the plurality of instruction addresses,
generate a plurality of nodes in the LDFG corresponding to the plurality of instruction addresses,
generate one or more edges in the LDFG based on the plurality of instruction addresses, and
assign one or more operational latencies corresponding to one or more instructions of the plurality of instructions to one or more nodes of the plurality of nodes; and,
wherein to build the SDFG, the control circuit is configured to:
generate a candidate matrix for a first instruction of the plurality of instructions, the candidate matrix comprising a plurality of elements, a subset of the plurality of elements corresponding to one or more instructions used as source in the first instruction, the planar grid comprising the candidate matrix,
determine a plurality of data transfer latencies from the one or more instructions for the subset of the plurality of elements, and
assign the first instruction to a first element of the subset of the plurality of elements, the first element having a minimum data transfer latency of the plurality of data transfer latencies.

20. The circuit of claim 14, wherein to configure the spatial accelerator, the control circuit is configured to:
map a plurality of virtual coordinates of the planar grid to a plurality of physical processing elements of the spatial accelerator.
